(19) United States
(12) Patent Application Publication
(10) Pub. No.: US 2020/0035381 A1
(43) Pub. Date: Jan. 30, 2020

(54) COPPER FIBER NONWOVEN FABRIC FOR WIRING, WIRING UNIT, METHOD FOR COOLING COPPER FIBER NONWOVEN FABRIC FOR WIRING, AND TEMPERATURE CONTROL METHOD FOR COPPER FIBER NONWOVEN FABRIC FOR WIRING

(71) Applicant: Tomoegawa Co., Ltd, Tokyo (JP)

(72) Inventors: Daisuke Muramatsu, Shizuoka-shi (JP); Tatsunari Inoue, Shizuoka-shi (JP)

(21) Appl. No.: 16/477,307

(22) PCT Filed: Jan. 15, 2018
(86) PCT No.: PCT/JP2018/000827

§ 371 Date: Jul. 11, 2019

(30) Foreign Application Priority Data
Jan. 16, 2017 (JP) 2017-005468

(51) Int. Cl. H01B 7/42; D04H 1/4234; H01B 5/00

(52) U.S. Cl. CPC H01B 7/423; D10B 2401/04; H01B 5/00; D04H 1/4234

(57) ABSTRACT

A copper fiber nonwoven fabric for wiring in which copper fibers are partially bound to each other, wherein when a gas in a standard state is allowed to pass through the copper fiber nonwoven fabric for wiring, in a state where a constant current is kept flowing to maintain a temperature of 80° C., perpendicularly with respect to a plane of the copper fiber nonwoven fabric for wiring for 1 minute at a flow rate of 20 L/min per 1 cm² of cross sectional area, a temperature of the copper fiber nonwoven fabric for wiring decreases by at least 30° C.

### TECHNICAL FIELD

The present invention relates to a copper fiber nonwoven fabric for wiring, as a material for wiring, in which copper fibers are partially bound to each other; a unit for wiring; a method for cooling a copper fiber nonwoven fabric for wiring; and a temperature control method.

Priority is claimed on Japanese Patent Application No. 2017-005468, filed Jan. 16, 2017, the content of which is incorporated herein by reference.

### BACKGROUND ART

A power semiconductor device (hereinafter referred to as a semiconductor power module) converts a direct current input into and outputs as an alternating current of an arbitrary frequency using a semiconductor, and is used in various devices such as an inverter corresponding to motor control or various applications or an uninterruptible power supply (UPS).

At this time, a bus bar or the like which is a conductive plate material having a large electrical capacity is used as a wiring material.

Here, the electronic devices in the power module, for example, field effect transistors (FETs), diodes, and the like, reach a high temperature due to the flow of a large current.

Accordingly, in order to suppress a temperature increase of each electronic device and operate it in a stable manner, it is necessary to efficiently dissipate the heat generated in the electronic device to the outside of the device.

Accordingly, Patent Document 1 describes an electronic circuit unit in which a bus bar and a heat-generating electronic device terminal such as a power transistor are connected, and heat generated in the electronic device is dissipated by the circuit bus bar itself.

### CITATION LIST

[Patent Document]

[Patent Document 1] Japanese Unexamined Patent Application, First Publication No. Hei 8-274421

### SUMMARY OF INVENTION

### Technical Problem

However, in the electronic circuit unit disclosed in Patent Document 1, since the bus bar is usually a plate-like conductor such as copper which is not provided with an insulating coating, when it is configured so that a large current flows to reach a high temperature, there was a possibility that the heat dissipation effect in the electronic circuit unit may be insufficient only with the heat dissipation by the bus bar.

The present invention has been made in order to solve the problems as described above, and provides a wiring material having a high heat dissipation effect.

### Solution to Problem

As a result of intensive studies, the inventors of the present invention have discovered that if a copper fiber nonwoven fabric in which copper fibers are partially bound to each other is used as a wiring material, when a gas in a standard state is allowed to pass through the copper fiber nonwoven fabric, maintained at a constant temperature, perpendicularly with respect to a plane of the copper fiber nonwoven fabric for a certain period of time at a constant flow rate, the temperature of the copper fiber nonwoven fabric becomes lower than that of a copper foil or copper plate, leading to the invention of a copper fiber nonwoven fabric for wiring which can make the heat dissipation properties higher than those of the copper foil or copper plate.

That is, the present invention (1) is a copper fiber nonwoven fabric for wiring in which copper fibers are partially bound to each other, wherein when a gas in a standard state is allowed to pass through the aforementioned copper fiber nonwoven fabric for wiring, in a state where a constant current is kept flowing to maintain a temperature of 80° C., perpendicularly with respect to a plane of the aforementioned copper fiber nonwoven fabric for wiring for 1 minute at a flow rate of 20 L/min per 1 cm² of cross sectional area, a temperature of the aforementioned copper fiber nonwoven fabric for wiring decreases by at least 30° C.

The present invention (2) is a copper fiber nonwoven fabric for wiring according to the aforementioned invention (1), wherein an average fiber diameter of the aforementioned copper fiber is from 1 μm to 30 μm, a thickness of the aforementioned copper fiber nonwoven fabric is from 20 μm to 5 mm, a space factor of the aforementioned copper fiber nonwoven fabric is 50% or less, and a coefficient of variation of weighing of the aforementioned copper fiber nonwoven fabric is 10% or less.

The present invention (3) is a wiring unit including the copper fiber nonwoven fabric for wiring according to the aforementioned invention (1), and a gas passage means for allowing a gas to pass through the aforementioned copper fiber nonwoven fabric for wiring.

The present invention (4) is the wiring unit according to the aforementioned invention (2), wherein the aforementioned gas passage means includes a depressurization mechanism for depressurizing the inside thereof.

The present invention (5) is a wiring unit in which the copper fiber nonwoven fabric for wiring according to the aforementioned invention (1) is accommodated in a gas channel through which a gas flows.

The present invention (6) is a method for cooling a copper fiber nonwoven fabric for wiring, the method including allowing a gas to pass through a copper fiber nonwoven fabric for wiring in which copper fibers are partially bound to each other, thereby lowering a temperature of the aforementioned copper fiber nonwoven fabric for wiring.

The present invention (7) is a method for controlling a temperature of a copper fiber nonwoven fabric for wiring, the method including: a step of energizing a copper fiber nonwoven fabric for wiring in which copper fibers are partially bound to each other; and a step of allowing a gas to pass through the aforementioned copper fiber nonwoven fabric for wiring, thereby controlling the temperature thereof.

The present invention (8) is a method for controlling a temperature of a copper fiber nonwoven fabric for wiring, the method including: a step of allowing a gas to pass through a copper fiber nonwoven fabric for wiring in which copper fibers are partially bound to each other; and a step of energizing the aforementioned copper fiber nonwoven fabric for wiring.

### Advantageous Effects of Invention

The copper fiber nonwoven fabric for wiring of the present invention is a copper fiber nonwoven fabric for wiring in which copper fibers are partially bound to each other, wherein when a gas in a standard state is allowed to pass through the aforementioned copper fiber nonwoven fabric for wiring, in a state where a constant current is kept flowing to maintain a temperature of 80° C., perpendicularly with respect to a plane of the aforementioned copper fiber nonwoven fabric for wiring for 1 minute at a flow rate of 20 L/min per 1 cm² of cross sectional area, a temperature of the aforementioned copper fiber nonwoven fabric for wiring decreases by at least 30° C. Since the temperature of the copper fiber nonwoven fabric for wiring is lowered than that of the copper foil or copper plate, the heat dissipation properties can be made higher than those of the copper foil or copper plate. Furthermore, by adjusting the flow rate of the gas passing through the copper fiber nonwoven fabric for wiring, it also becomes possible to keep the copper fiber nonwoven fabric for wiring constant at a desired temperature.

### BRIEF DESCRIPTION OF DRAWINGS

FIG. 1 is a SEM cross-sectional photograph of a copper fiber nonwoven fabric for wiring of an embodiment (Example 1) of the present invention.

FIG. 2 is a SEM cross-sectional photograph showing an example of a state where copper fibers are bound to each other in the copper fiber nonwoven fabric for wiring of the embodiment (Example 1) of the present invention.

FIG. 3 is a schematic view showing an example of a configuration for confirming heat dissipation properties according to the present invention.

FIG. 4 is a graph showing evaluation results of temperature change with time of the copper fiber nonwoven fabric for wiring of Example 1 and a copper foil of Comparative Example 1.

FIG. 5 is a schematic view showing a first embodiment of a wiring unit of the present invention.

FIG. 6 is a schematic view showing a second embodiment of the wiring unit of the present invention.

FIG. 7 is a mapping diagram of an individual cut piece of a copper fiber nonwoven fabric for wiring in order to measure a coefficient of variation of basis weight according to the present invention.

### DESCRIPTION OF EMBODIMENTS

A copper fiber nonwoven fabric for wiring of the present invention (hereinafter, also referred to as copper fiber nonwoven fabric) will be described in detail below, but the copper fiber nonwoven fabric for wiring of the present invention is not limited thereto.

### (Copper Fiber Nonwoven Fabric for Wiring)

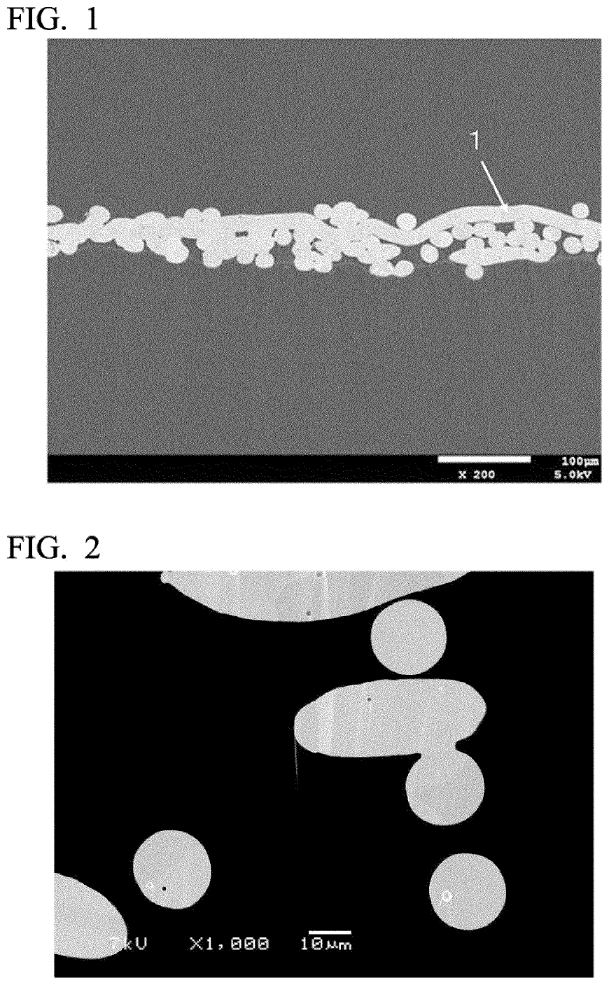

FIG. 1 is a SEM cross-sectional photograph of a copper fiber nonwoven fabric 1 for wiring of an embodiment (Example 1) of the present invention composed of copper fibers alone and produced using copper fibers. Further, FIG. 2 is an enlarged photograph of FIG. 1 and is a SEM cross-sectional photograph showing an example of a state where copper fibers of the copper fiber nonwoven fabric for wiring of the embodiment (Example 1) of the present invention are bound to each other.

The copper fiber nonwoven fabric for wiring of the present invention is a copper fiber nonwoven fabric for wiring in which copper fibers are partially bound to each other. In the present specification, the term “nonwoven fabric” refers to a sheet-like material in which fibers are randomly intertwined. The term “copper fiber nonwoven fabric” refers to a nonwoven fabric containing at least a fiber made of copper. Here, the copper fiber may be composed of only a copper component, or may have another metal component or another component other than the metal component. The expression “copper fibers are partially bound to each other” means that a portion of the copper fibers is physically fixed, and the copper fibers may be directly fixed with each other, or portions of the copper fibers may be indirectly fixed with each other via another metal component or another component other than the metal component.

More specifically, the expression “copper fibers are partially bound to each other” means that the copper fiber nonwoven fabric preferably has one or more binding portions, and more preferably 10 or more binding portions, per 1 cm³.

Furthermore, the copper fiber nonwoven fabric for wiring of the present invention is characterized by having high heat dissipation properties, by which when a gas in a standard state is allowed to pass through the copper fiber nonwoven fabric for wiring, in a state where a constant current is kept flowing to maintain a constant temperature, perpendicularly with respect to a plane of the copper fiber nonwoven fabric for wiring for a certain period of time at a constant flow rate per 1 cm² of cross sectional area, a temperature of the copper fiber nonwoven fabric for wiring decreases by at least 30° C. Hereinafter, the heat dissipation properties of the copper fiber nonwoven fabric for wiring will be described in detail.

### (Configuration for Confirming Heat Dissipation Properties)

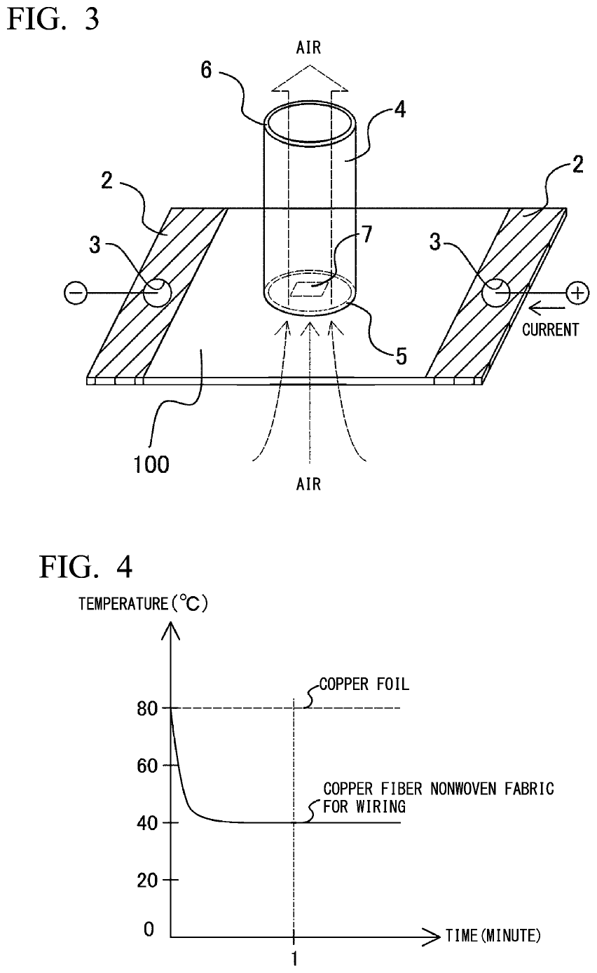

FIG. 3 is a schematic view showing an example of a configuration for confirming heat dissipation properties according to the present invention.

The configuration for confirming the heat dissipation properties of the copper fiber nonwoven fabric for wiring of the present invention is a configuration enabling confirmation by allowing a gas in a standard state (hereinafter, set to 1 bar, 25° C. (298.15 K)) to pass through the copper fiber nonwoven fabric for wiring, in a state where a constant current is kept flowing to maintain a constant temperature, perpendicularly with respect to a plane of the copper fiber nonwoven fabric for wiring for a certain period of time at a constant flow rate per 1 cm² of cross sectional area.

More specifically, as shown in FIG. 3, a copper fiber nonwoven fabric 100 for wiring as a sample for confirming heat dissipation properties is formed into a rectangular shape so as to facilitate confirmation of the heat dissipation properties, and in an area of each end portion in the long side direction (end portions 2), an Ag paste is applied so that a constant temperature can be maintained in a state where a constant current is allowed to flow through the copper fiber nonwoven fabric 100 for wiring before confirming the heat dissipation properties, and terminal holes 3 are provided so that a terminal for allowing a current to flow can be provided.

Next, a nozzle 4 as a gas passage means for allowing a gas in the standard state to pass through the inside of the copper fiber nonwoven fabric for wiring perpendicularly with respect to a plane of the copper fiber nonwoven fabric 100 for wiring is installed by bringing a contact point into close contact perpendicularly with respect to the plane (on the planar surface) of the copper fiber nonwoven fabric 100 for wiring so that no leakage of the gas in a standard state occurs and air from the outside does not enter.

There is no particular limitation on the method for installing the gas passage means, as long as it can be configured so that the gas in the standard state is allowed to pass through the inside of the copper fiber nonwoven fabric for wiring perpendicularly with respect to the plane of the copper fiber nonwoven fabric 100 for wiring for a certain period of time at a constant flow rate per 1 cm² of cross sectional area, no leakage of the gas in the standard state occurs between the copper fiber nonwoven fabric 100 for wiring and the nozzle 4, and air from the outside does not enter. For example, the gas passage means may be installed by being brought into contact, in a non-perpendicular direction, such as an oblique direction, with respect to the plane of the copper fiber nonwoven fabric 100 for wiring.

Here, a known material can be used as the material of the nozzle 4, and the shape and size of the nozzle are also not particularly limited and known techniques can be used as long as they are capable of allowing a gas in the standard state to pass through the inside of the copper fiber nonwoven fabric 100 for wiring perpendicularly with respect to the plane of the copper fiber nonwoven fabric 100 for wiring for a certain period of time at a constant flow rate per 1 cm² of cross sectional area, preventing the occurrence of leakage of the gas in the standard state between the copper fiber nonwoven fabric 100 for wiring and the nozzle 4, and preventing the entering of air from the outside.

Further, by interposing an adhesive having the same shape as that of a nozzle inlet end face 5 between the copper fiber nonwoven fabric 100 for wiring and the nozzle 4, the contact point between the copper fiber nonwoven fabric 100 for wiring and the nozzle 4 can also be made even closer. As the adhesive used here, for example, known materials such as a silicone adhesive and a silicone gel sheet can be used.

In the present configuration, as a specific example, an example using a metal nozzle in which the nozzle is made of steel and a silicone gel sheet (not shown in FIG. 3) as the adhesive can be mentioned.

Furthermore, as shown in FIG. 3, a thermocouple 7 for measuring the temperature change of the copper fiber nonwoven fabric 100 for wiring is installed using a heat resistant tape in a region on the planar surface of the copper fiber nonwoven fabric 100 for wiring, which is, on the planar surface of the copper fiber nonwoven fabric 100 for wiring, on the opposite side of an area corresponding to the inside of the nozzle inlet end face 5 where the gas in the standard state passes, and has a symmetric relation with the area corresponding to the inside of the nozzle inlet end face 5.

Here, as the heat resistant tape, a known material can be used as long as it has heat resistance in the present configuration.

In the present configuration, as a specific example, an example of using a polyimide tape as the heat resistant tape can be mentioned.

In the nozzle 4 in the present configuration, a nozzle outlet end face 6 is connected to a depressurization mechanism (not shown) such as an aspirator via, for example, a plastic tube (not shown). That is, the gas in the standard state which has passed through perpendicularly with respect to the plane of the copper fiber nonwoven fabric 100 for wiring for a certain period of time at a constant flow rate per 1 cm² of cross sectional area is allowed to flow from the nozzle inlet end face 5 toward the nozzle outlet end face 6 due to suction by decompression in the nozzle 4.

In the present configuration, an example is given in which the gas in the standard state flows due to suction by decompression using the depressurization mechanism, but, for example, a method of flowing a gas by pressure delivery may be used as long as the gas in the standard state can be allowed to pass through the inside of the copper fiber nonwoven fabric for wiring for a certain period of time at a constant flow rate per 1 cm² of cross sectional area, perpendicularly with respect to the plane of the copper fiber nonwoven fabric for wiring. In this case, in order to pressurize the gas, a pressurization mechanism such as a compressor or the like for pressurizing the gas can be connected to a location other than the nozzle outlet end face 6 (for example, on the planar surface of the copper fiber nonwoven fabric 100 for wiring which is the surface on the opposite side of the nozzle 4 side, or the like). As a specific example, an example in which a configuration is adopted so that a new nozzle is provided on the planar surface of the copper fiber nonwoven fabric 100 for wiring, which is a surface on the opposite side of the nozzle 4 side in FIG. 3, and that the copper fiber nonwoven fabric 100 for wiring is sandwiched by the nozzles using, for example, a flange or the like, and the pressurization mechanism is connected via a plastic tube to an end face of the new nozzle on the side opposite to the side of the copper fiber nonwoven fabric 100 for wiring can be mentioned.

Known mechanisms such as an aspirator, an ejector and a compressor can be used as the depressurization mechanism and the pressurization mechanism.

### (Conditions for Confirming Heat Dissipation Properties)

The conditions for confirming the heat dissipation properties of the copper fiber nonwoven fabric for wiring according to the present invention are as follows: a gas in a standard state is allowed to pass through the copper fiber nonwoven fabric for wiring in a state in which a constant current is kept flowing and a constant temperature is maintained, perpendicularly with respect to the plane of the copper fiber nonwoven fabric for wiring for a certain period of time at a constant flow rate per 1 cm² of cross sectional area.

More specifically, first, although the temperature of the copper fiber nonwoven fabric for wiring in a state where a constant current is kept flowing and a constant temperature is maintained is not particularly specified, it is preferable to maintain the temperature at 80° C. from the viewpoint of facilitating confirmation of the heat dissipation properties. Although the above-described current changes depending on the resistance value of the copper fiber nonwoven fabric for wiring, and is not particularly limited as long as the temperature of the copper fiber nonwoven fabric for wiring can be maintained at 80° C., the current is preferably 20 A in the present invention.

Subsequently, air, oxygen, nitrogen, argon and the like can be used appropriately as a gas in the standard state to be used, but in the present invention, it is preferable to use air as the gas in the standard state for convenience.

In the copper fiber nonwoven fabric for wiring, it is preferable to allow the gas in the standard state to pass through perpendicularly with respect to the plane of the copper fiber nonwoven fabric for wiring for 1 minute at a flow rate of 20 L/min per 1 cm² of cross sectional area. If the flow rate of the gas in the standard state is less than 20 L/min, because the flow rate is insufficient, it would be difficult to achieve a temperature drop of at least 30° C. of the copper fiber nonwoven fabric for wiring when it was allowed to pass through the copper fiber nonwoven fabric for wiring for 1 minute.

Further, the upper limit of the flow rate of the gas in the standard state according to the present invention may be a flow rate at which the gas can pass through between the copper fibers of the copper fiber nonwoven fabric for wiring, and the flow rate can be increased to such an extent that deformation/rupture of the copper fiber nonwoven fabric for wiring, breakage of the close contact between the copper fiber nonwoven fabric for wiring and the nozzle, leakage of the gas in the standard state, and inflow of air from the outside do not occur. In addition, as the flow rate of the gas in the standard state increases, the degree of temperature drop of the copper fiber nonwoven fabric for wiring will increase.

The measurement environment at the time of confirming the heat dissipation properties is not particularly specified, but in the present invention, the measurement is made in an environment at a temperature of 23±5° C. and a humidity of 60±10%.

### (Conditions for Heat Dissipation Properties)

The conditions for the heat dissipation properties of the copper fiber nonwoven fabric for wiring according to the present invention are as follows: when a gas in a standard state is allowed to pass through the copper fiber nonwoven fabric for wiring in a state in which a constant current is kept flowing and a constant temperature is maintained, perpendicularly with respect to the plane of the copper fiber nonwoven fabric for wiring for a certain period of time at a constant flow rate per 1 cm² of cross sectional area, the temperature of the copper fiber nonwoven fabric for wiring decreases by at least 30° C. For this reason, the copper fiber nonwoven fabric for wiring of the present invention has high heat dissipation properties.

More specifically, the temperature of the copper fiber nonwoven fabric for wiring of the present invention is preferably lowered by at least 30° C., and more preferably by 40° C. This is because if the temperature is lowered by less than 30° C., the degree of temperature drop with respect to that of the copper foil or copper plate would be small, and it would be difficult to exhibit superiority over the copper foil or copper plate.

Since the copper fiber nonwoven fabric for wiring of the present invention is a copper fiber nonwoven fabric for wiring in which the copper fibers are partially bound to each other, many voids are formed inside the copper fiber nonwoven fabric for wiring. Therefore, it is considered that by allowing the gas in the standard state to pass through inside the copper fiber nonwoven fabric for wiring perpendicularly with respect to the plane of the copper fiber nonwoven fabric for a certain period of time at a constant flow rate, the temperature of the copper fiber nonwoven fabric for wiring can be made lower than that of the copper foil or copper plate, and the heat dissipation properties can be enhanced.

Subsequently, a wiring unit using the copper fiber nonwoven fabric for wiring of the present invention will be described in detail below as an application example of the copper fiber nonwoven fabric for wiring of the present invention, but the wiring unit for wiring of the present invention is not limited thereto.

### (Wiring Unit 1)

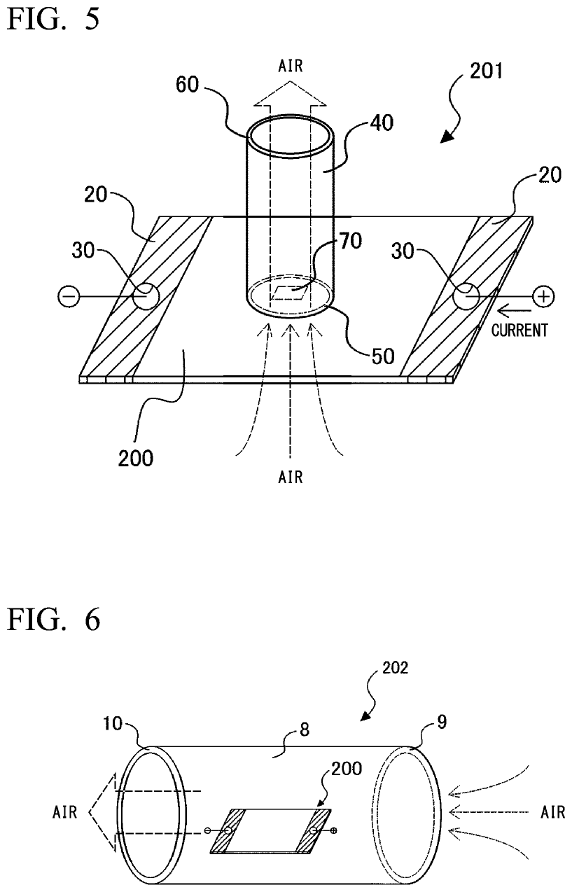

FIG. 5 is a schematic view showing a first embodiment of the wiring unit of the present invention, and has the same configuration as in FIG. 3 described above, which is a schematic view showing an example of the configuration for confirming the heat dissipation properties according to the present invention.

A copper fiber nonwoven fabric 200 for wiring in a wiring unit 1 (201) of the present invention is a copper fiber nonwoven fabric for wiring of the present invention, and is formed into a rectangular shape so as to facilitate confirmation of the heat dissipation properties. In an area of each end portion in the long side direction (end portions 20), an Ag paste for allowing a constant current to flow through the copper fiber nonwoven fabric 200 for wiring is applied so as to maintain the copper fiber nonwoven fabric 200 for wiring at a constant temperature, and terminal holes 30 are provided so that a terminal for allowing a current to flow can be provided.

On a planar surface of the copper fiber nonwoven fabric 200 for wiring, a nozzle 40 as a gas passage means for allowing a gas in a standard state to pass through the inside of the copper fiber nonwoven fabric for wiring perpendicularly with respect to the plane of the copper fiber nonwoven fabric 200 for wiring is installed by bringing a contact point into close contact perpendicularly with respect to the plane (on the planar surface) of the copper fiber nonwoven fabric 200 for wiring so that no leakage of the gas in a standard state occurs and air from the outside does not enter.

There is no particular limitation on the method for installing the gas passage means, as long as it can be configured so that the gas in the standard state is allowed to pass through the inside of the copper fiber nonwoven fabric for wiring perpendicularly with respect to the plane of the copper fiber nonwoven fabric 200 for wiring for a certain period of time at a constant flow rate per 1 cm² of cross sectional area, no leakage of the gas in the standard state occurs between the copper fiber nonwoven fabric 200 for wiring and the nozzle 40, and air from the outside does not enter. For example, the gas passage means may be installed by being brought into close contact at a contact point, in a non-perpendicular direction, such as an oblique direction, with respect to the plane of the copper fiber nonwoven fabric 100 for wiring.

Here, a known material can be used as the material of the nozzle 40, and the shape and size of the nozzle are also not particularly limited and known techniques can be used as long as they are capable of allowing a gas in the standard state to pass through the inside of the copper fiber nonwoven fabric 200 for wiring perpendicularly with respect to the plane of the copper fiber nonwoven fabric 200 for wiring for a certain period of time at a constant flow rate per 1 cm² of cross sectional area, preventing the occurrence of leakage of the gas in the standard state between the copper fiber nonwoven fabric 200 for wiring and the nozzle 40, and preventing the entering of air from the outside.

Further, by interposing an adhesive having the same shape as that of a nozzle inlet end face 50 between the copper fiber nonwoven fabric 200 for wiring and the nozzle 40, the contact point between the copper fiber nonwoven fabric 200 for wiring and the nozzle 40 can also be made even closer. As the adhesive used here, for example, known materials such as a silicone adhesive and a silicone gel sheet can be used.

In the present unit 1, as a specific example, an example using a metal nozzle in which the nozzle is made of steel and a silicone gel sheet (not shown in FIG. 5) as the adhesive can be mentioned.

Furthermore, as shown in FIG. 5, a thermocouple 70 for measuring the temperature change of the copper fiber nonwoven fabric 200 for wiring is installed using a heat resistant tape in a region on the planar surface of the copper fiber nonwoven fabric 200 for wiring, which is, on the planar surface of the copper fiber nonwoven fabric 200 for wiring, on the opposite side of an area corresponding to the inside of the nozzle inlet end face 50 where the gas in the standard state passes, and has a symmetric relation with the area corresponding to the inside of the nozzle inlet end face 50.

Here, as the heat resistant tape, a known material can be used as long as it has heat resistance in the present unit 1.

In the present unit 1, as a specific example, an example using a polyimide tape as the heat resistant tape can be mentioned.

(Connection of Wiring Unit 1 with Mechanism)

In the nozzle 40 in the present unit 1, a nozzle outlet end face 60 is connected to a depressurization mechanism (not shown) such as an aspirator via, for example, a plastic tube (not shown). That is, the gas in the standard state which has passed through perpendicularly with respect to the plane of the copper fiber nonwoven fabric 200 for wiring for a certain period of time at a constant flow rate per 1 cm² of cross sectional area is allowed to flow from the nozzle inlet end face 50 toward the nozzle outlet end face 60 due to suction by decompression in the nozzle 40.

In the present unit 1, an example is given in which the gas in the standard state flows due to suction by decompression using the depressurization mechanism, but, for example, a method of flowing a gas by pressure delivery may be used as long as the gas in the standard state can be allowed to pass through the inside of the copper fiber nonwoven fabric for wiring for a certain period of time at a constant flow rate per 1 cm² of cross sectional area, perpendicularly with respect to the plane of the copper fiber nonwoven fabric for wiring. In this case, in order to pressurize the gas, a pressurization mechanism such as a compressor or the like for pressurizing the gas can be connected to a location other than the nozzle outlet end face 60 (for example, on the planar surface of the copper fiber nonwoven fabric 200 for wiring which is the surface on the opposite side of the nozzle 40 side, or the like). As a specific example, an example in which a configuration is adopted so that a new nozzle is provided on the planar surface of the copper fiber nonwoven fabric 200 for wiring, which is a surface on the opposite side of the nozzle 40 side in FIG. 5, and that the copper fiber nonwoven fabric 200 for wiring is sandwiched by the nozzles using, for example, a flange or the like, and the pressurization mechanism is connected via a plastic tube to an end face of the new nozzle on the side opposite to the side of the copper fiber nonwoven fabric 200 for wiring can be mentioned.

Known mechanisms such as an aspirator, an ejector and a compressor can be appropriately used as the depressurization mechanism and the pressurization mechanism.

In the present unit 1, by using the copper fiber nonwoven fabric for wiring, it is possible not only to have high heat dissipation properties as described above, but also to maintain the copper fiber nonwoven fabric for wiring in the present unit 1 constant at a desired temperature (equal to or below the temperature of the copper fiber nonwoven fabric for wiring before the passage of the gas in the standard state) by adjusting the flow rate of the gas in the standard state which is allowed to pass through the copper fiber nonwoven fabric for wiring.

### (Wiring Unit 2)

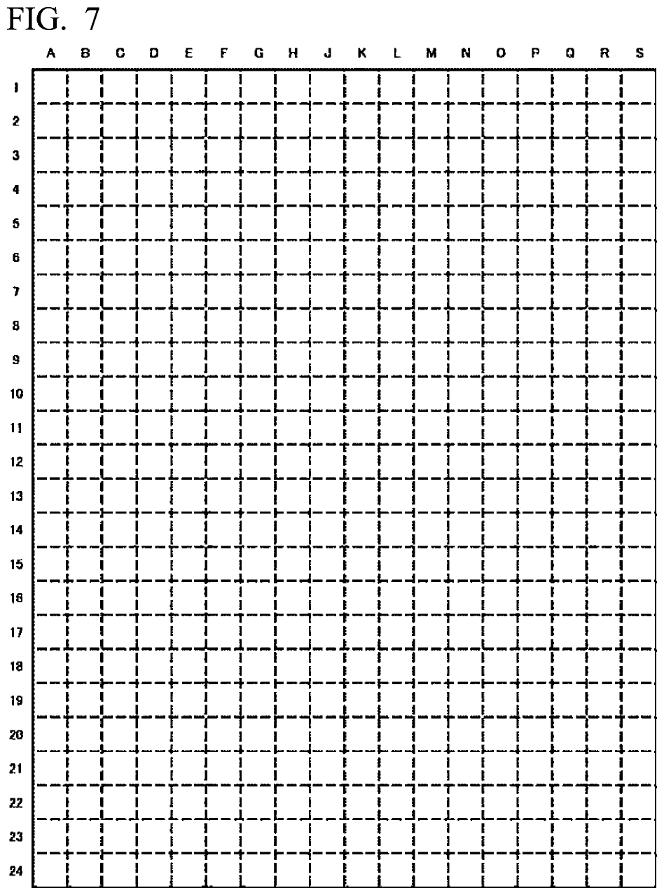

Next, FIG. 6 is a schematic view showing a second embodiment of the wiring unit of the present invention.

A copper fiber nonwoven fabric 200 for wiring in a wiring unit 2 (202) of the present invention uses the copper fiber nonwoven fabric for wiring of the present invention in the same manner as that used in the wiring unit 1 described above. In the present unit 2, it is configured so that the copper fiber nonwoven fabric 200 for wiring in which a constant current is allowed to flow and a constant temperature is maintained is fixed and accommodated in a gas channel of a nozzle-like gas channel 8 inside of which a gas in a standard state (although it is described as air as an example in the present unit 2 in FIG. 6, oxygen, nitrogen, argon or the like can be appropriately used) flows, and the gas in the standard state is allowed to flow inside the gas channel 8 from a gas channel inlet end face 9 to a gas channel outlet end face 10 along the surface and the inside of the copper fiber nonwoven fabric for wiring.

Here, the method for fixing the copper fiber nonwoven fabric 200 for wiring inside the gas channel 8 is not particularly limited, and a known technique can be used. Although not illustrated in FIG. 6, as a specific example in the present unit 2, an example using a screw can be mentioned.

Furthermore, regarding arrangement of the copper fiber nonwoven fabric 200 for wiring when fixed and accommodated in the gas channel 8, in FIG. 6, an example is given in which it is fixed and accommodated in an arrangement so that the long side direction of the rectangular shape of the copper fiber nonwoven fabric 200 for wiring coincides with the flow direction of the gas in the standard state (air) in the gas channel 8. It is not particularly limited as long as the gas in the standard state can flow inside the gas channel 8 from the gas channel inlet end face 9 to the gas channel outlet end face 10 along the surface and the inside of the copper fiber nonwoven fabric for wiring. For example, according to the situation, it is possible to appropriately adjust the arrangement into an arrangement in which the short side direction of the rectangular shape coincides with the flow direction of the gas in the standard state, an arrangement in which the long side direction of the rectangular shape is inclined with respect to the flow direction of the gas in the standard state, an arrangement in which the plane of the copper fiber nonwoven fabric 200 for wiring is inclined with respect to the flow direction of the gas in the standard state, or the like.

Here, although a known material can be used as the material of the gas channel 8, the copper fiber nonwoven fabric 200 for wiring and the gas channel 8 must be in a mutually insulating relationship. As a material for this purpose, for example, materials such as an insulating material and those obtained by covering the surface of a metal material with an insulating material can be suitably adjusted according to the situation.

Furthermore, the shape and size of the gas channel are also not particularly limited as long as the gas in the standard state can flow inside the gas channel 8 from the gas channel inlet end face 9 to the gas channel outlet end face 10 along the surface and the inside of the copper fiber nonwoven fabric for wiring, and can be appropriately adjusted according to the situation, for example, into a spiral shape or the like.

In the present unit 2, as a specific example, an example using a gas channel in which the gas channel 8 is made of ceramic and has a nozzle shape can be mentioned.

Furthermore, although not shown in FIG. 6, a thermocouple is installed on the planar surface of the copper fiber nonwoven fabric 200 for wiring using a heat resistant tape in order to measure the temperature change of the copper fiber nonwoven fabric 200 for wiring.

Here, as the heat resistant tape, a known material can be used as long as it has heat resistance in the present unit 2.

In the present unit 2, as a specific example, an example using a polyimide tape as the heat resistant tape can be mentioned.

(Connection of Wiring Unit 2 with Mechanism)

In the gas channel 8 in the present unit 2, the gas channel outlet end face 10 is connected to a depressurization mechanism (not shown) such as an aspirator via, for example, a plastic tube (not shown). That is, the gas in the standard state is allowed to flow from the gas channel inlet end face 9 toward the gas channel outlet end face 10 due to suction by decompression in the gas channel 8.

In the present unit 2, an example is given in which the gas in the standard state flows due to suction by decompression using the depressurization mechanism, but, for example, a method of flowing a gas by pressure delivery may be used as long as the gas in the standard state can be allowed to flow inside the gas channel 8 from the gas channel inlet end face 9 to the gas channel outlet end face 10 along the surface and the inside of the copper fiber nonwoven fabric for wiring. In this case, in order to pressurize the gas, a pressurization mechanism such as a compressor or the like for pressurizing the gas can be connected, not to the gas channel outlet end face 10 but to the gas channel inlet end face 9. As a specific example, an example in which a pressurization mechanism is connected to the gas channel inlet end surface 9 in FIG. 6 via a plastic tube can be mentioned.

Known mechanisms such as an aspirator, an ejector and a compressor can be appropriately used as the depressurization mechanism and the pressurization mechanism.

It is considered that since the copper fiber nonwoven fabric for wiring is fixed and accommodated in the gas channel in the present unit 2, by bringing a portion of the gas in the standard state flowing inside the gas channel into contact at various angles with the surface and the inside of the copper fiber nonwoven fabric for wiring where many voids have been formed, the temperature of the copper fiber nonwoven fabric for wiring can be made lower than that of the copper foil or copper plate, and the heat dissipation properties can be enhanced.

Furthermore, as in the unit 1, it is also possible to maintain the copper fiber nonwoven fabric for wiring in the present unit 2 constant at a desired temperature (equal to or below the temperature of the copper fiber nonwoven fabric for wiring before the passage of the gas in the standard state) by adjusting the flow rate of the gas in the standard state which is allowed to pass through the inside of the gas channel.

Subsequently, a method of cooling the copper fiber nonwoven fabric for wiring of the present invention will be described in detail below, although the method of cooling the copper fiber nonwoven fabric for wiring of the present invention is not limited thereto.

### (Method of Cooling Copper Fiber Nonwoven Fabric for Wiring)

The method of cooling the copper fiber nonwoven fabric for wiring of the present invention is a method characterized in that the temperature of the copper fiber nonwoven fabric for wiring is lowered by allowing the gas in the standard state to pass through the copper fiber nonwoven fabric for wiring, and the following two methods can be exemplified.

A first cooling method (cooling method 1) is a method in which a gas (for example, a gas in a standard state) is allowed to pass through a copper fiber nonwoven fabric for wiring perpendicularly with respect to a plane of the copper fiber nonwoven fabric for wiring for a certain period of time at a constant flow rate per 1 cm² of cross sectional area (related to the configuration for confirming the heat dissipation properties and the wiring unit 1).

A second cooling method (cooling method 2) is a method in which a copper fiber nonwoven fabric for wiring is fixed and accommodated in a gas channel inside of which a gas (for example, a gas in a standard state) flows, and the gas is allowed to flow along the surface and the inside of the copper fiber nonwoven fabric for wiring by flowing the gas inside the gas channel from a gas channel inlet end face to a gas channel outlet end face (related to the wiring unit 2).

As a specific example of the cooling method, an example using the connection with each of the above wiring units and mechanisms (depressurization or pressurization) can be mentioned.

With regard to the method of cooling the copper fiber nonwoven fabric for wiring of the present invention, since the copper fiber nonwoven fabric for wiring of the present invention is a copper fiber nonwoven fabric for wiring in which copper fibers are partially bound to each other, many voids are formed inside the copper fiber nonwoven fabric for wiring. Therefore, it is considered that as a result of cooling the copper fiber nonwoven fabric for wiring by allowing a gas (for example, a gas in a standard state) to pass through perpendicularly with respect to the plane of the copper fiber nonwoven fabric for wiring, or by flowing it along the surface and the inside of the copper fiber nonwoven fabric for wiring in the gas channel, the temperature of the copper fiber nonwoven fabric for wiring can be made lower than that of the copper foil or copper plate, and the heat dissipation properties can be enhanced.

Furthermore, by adjusting the flow rate of a gas (for example, a gas in a standard state) which is allowed to pass through the copper fiber nonwoven fabric for wiring or through the inside of the gas channel, it is also possible to maintain the copper fiber nonwoven fabric for wiring constant at a desired temperature (equal to or below the temperature of the copper fiber nonwoven fabric for wiring before the gas passage).

Subsequently, a method of controlling the temperature of the copper fiber nonwoven fabric for wiring of the present invention will be described in detail below, although the method of controlling the temperature of the copper fiber nonwoven fabric for wiring of the present invention is not limited thereto.

### (Method of Controlling Temperature of Copper Fiber Nonwoven Fabric for Wiring)

The method of controlling the temperature of the copper fiber nonwoven fabric for wiring of the present invention is a method characterized in that the temperature of the copper fiber nonwoven fabric for wiring is controlled by combining two steps, and a method by the following two steps can be exemplified.

A first step is a step of energizing the copper fiber nonwoven fabric for wiring, and a second step is a step of allowing a gas to pass through the copper fiber nonwoven fabric for wiring.

The order of the above steps is not limited, and either of them may be performed first.

Subsequently, each step will be described in detail below.

### (Step of Energizing Copper Fiber Nonwoven Fabric for Wiring)

The step of energizing the copper fiber nonwoven fabric for wiring of the present invention as the first step is a step of allowing a constant current to flow through the copper fiber nonwoven fabric for wiring, thereby maintaining the copper fiber nonwoven fabric for wiring at a constant temperature.

As a specific example, for example, an example in which a copper fiber nonwoven fabric for wiring is formed into a rectangular shape, an Ag paste for applying a constant current is applied to an area of each end portion in the long side direction (end portion) and a terminal hole is provided so that a terminal for applying a current can be provided, then the terminal is connected to the terminal hole, and a constant current is applied to the copper fiber nonwoven fabric for wiring via the terminal to maintain the copper fiber nonwoven fabric for wiring at a constant temperature can be mentioned.

### (Step of Allowing Gas to Pass Through Copper Fiber Nonwoven Fabric for Wiring)

The step of allowing a gas to pass through the copper fiber nonwoven fabric for wiring of the present invention as the second step is a step of allowing a gas (for example, a gas in a standard state) to pass through the copper fiber nonwoven fabric for wiring. As a result, the temperature of the copper fiber nonwoven fabric for wiring is lowered, or, in addition thereto, is kept constant at a desired temperature (equal to or below the temperature of the copper fiber nonwoven fabric for wiring before the gas passage). That is, the present step may also become a step of controlling the temperature of the copper fiber nonwoven fabric for wiring by allowing a gas to pass therethrough.

As a specific example, for example, an example in which a gas (for example, a gas in a standard state) is allowed to pass through perpendicularly with respect to a plane of the copper fiber nonwoven fabric for wiring for a certain period of time at a constant flow rate per 1 cm² of cross sectional area (related to the configuration for confirming the heat dissipation properties and the wiring unit 1), and an example in which a copper fiber nonwoven fabric for wiring is fixed and accommodated in a gas channel inside of which a gas flows, and the gas is allowed to flow along the surface and the inside of the copper fiber nonwoven fabric for wiring by flowing the gas inside the gas channel from a gas channel inlet end face to a gas channel outlet end face (related to the wiring unit 2) can be mentioned.

By performing each of the above steps, the method of controlling the temperature of the copper fiber nonwoven fabric for wiring of the present invention can be carried out.

Here, in the case where the first step of the two steps is a step of energizing the copper fiber nonwoven fabric for wiring, since a gas (for example, a gas in a standard state) is allowed to pass through the copper fiber nonwoven fabric for wiring maintained at a constant temperature, it becomes possible to lower the temperature of the copper fiber nonwoven fabric for wiring in which copper fibers are partially bound to each other and in which many voids are formed inside. Alternatively, in addition to this, since it becomes possible to keep the temperature constant at a desired temperature (equal to or below the temperature of the copper fiber nonwoven fabric for wiring before the gas passage), the temperature of the copper fiber nonwoven fabric for wiring can be controlled.

Further, in the case where the first step of the two steps is a step of allowing a gas to pass through the copper fiber nonwoven fabric for wiring, since the copper fiber nonwoven fabric for wiring in which the temperature is kept at a constant temperature (equal to or below the temperature of the copper fiber nonwoven fabric for wiring before the gas passage) is energized by passage of a gas (for example, a gas in a standard state), it becomes possible to keep the temperature constant at a desired temperature. Therefore, the temperature of the copper fiber nonwoven fabric for wiring can be controlled.

Subsequently, the characteristics of the copper fibers and the copper fiber nonwoven fabric used for the copper fiber nonwoven fabric for wiring of the present invention will be described in detail below.

### (Characteristics of Copper Fibers)

The average fiber diameter of the copper fibers used for the copper fiber nonwoven fabric for wiring of the present invention can be arbitrarily set within the range that does not impair the homogeneity of the nonwoven fabric, but is preferably from 1 μm to 30 μm, and more preferably from 2 μm to 20 μm. If it is less than 1 μm, the rigidity of the copper fibers is reduced, and the so-called lump tends to be formed when forming a nonwoven fabric, and if it exceeds 30 μm, the rigidity of the copper fibers may act to hinder the fiber entanglement. Further, the cross-sectional shape perpendicular to the longitudinal direction of the copper fibers may be any shape such as a circular shape, an elliptic shape, a substantially quadrangular shape, or an amorphous shape. In the present specification, the term “average fiber diameter” refers to an average value of area diameters (for example, an average value of 20 fibers) derived by calculating (for example, calculating using known software) a cross sectional area perpendicular to the longitudinal direction of the copper fibers based on the vertical cross-section at an arbitrary place of the copper fiber nonwoven fabric imaged with a microscope, and calculating a diameter of a circle having the same area as the aforementioned cross sectional area.

The average fiber length of the copper fibers used in the copper fiber nonwoven fabric for wiring of the present invention is preferably from 1 mm to 10 mm, and more preferably from 3 mm to 5 mm. If the average fiber length is within the above range, for example, when producing the copper fiber nonwoven fabric of the present invention by a paper making process, the so-called lump of copper fibers are unlikely to be formed, an effect of easily controlling the dispersion to a high degree can be expected, and an effect of improving the handling strength of the copper fiber nonwoven fabric is also easily brought about by the entanglement between the copper fibers. The “average fiber length” in the present specification is a value obtained by measuring, for example, 20 copper fibers with a microscope and averaging the measured values.

Further, when long metal fibers produced by a melt spinning method, drawing method or the like are cut to a desired fiber length, it is not realistic to cut the metal fibers one by one from the fineness of the metal fibers. Accordingly, although a method of bundling and cutting long metal fibers is used, in that case, it is preferable to cut the bundle of long metal fibers after sufficiently loosening it in advance. By loosening the fibers, it becomes easy to suppress the phenomenon in which the cut surfaces of the metal fibers adhere with each other at the time of cutting (for example, in the shape of a pine needle or the like), and since the metal fibers behave independently one by one when forming a nonwoven fabric, it becomes easy to obtain a metal fiber nonwoven fabric with higher homogeneity. It is particularly effective to use this method for copper fibers and the like with low hardness.

### (Characteristics of Copper Fiber Nonwoven Fabric)

The thickness of the copper fiber nonwoven fabric (excluding a coating layer and a resin layer) used for the copper fiber nonwoven fabric for wiring of the present invention can be adjusted to any thickness, but is preferably, for example, from 20 μm to 5 mm, and more preferably from 30 μm to 4 mm. When measurement is made, for example, at any number of measurement points in the copper fiber nonwoven fabric using a film thickness meter (for example, Digimatic Indicator ID-C112X: manufactured by Mitutoyo Corporation) of a terminal drop system by air, the thickness of the sheet in the present specification is an average value of these measured values.

The space factor of the copper fiber nonwoven fabric used for the copper fiber nonwoven fabric for wiring according to the present invention is preferably 50% or less, more preferably from 5% to 50%, and still more preferably from 15% to 40%. If the space factor exceeds 50%, the flexibility of the copper fiber nonwoven fabric may be reduced. The space factor in the present specification is a ratio of a portion where the fibers are present with respect to the volume of the copper fiber nonwoven fabric, and is calculated by the following formula from the basis weight and thickness of the copper fiber nonwoven fabric and the true density of the copper fiber (when the copper fiber nonwoven fabric is composed of only a single copper fiber). Further, when the copper fiber nonwoven fabric contains another metal component or a component other than the metal component, the space factor can be calculated by adopting a true density value reflecting the composition ratio.

Space factor (%)=(basis weight of copper fiber nonwoven fabric)/((thickness of copper fiber nonwoven fabric)×(true density of copper fiber))×100

The elongation percentage of the copper fiber nonwoven fabric used for the copper fiber nonwoven fabric for wiring of the present invention is preferably from 3% to 20%, and more preferably from 5% to 15%. When it is less than 3%, there is a possibility that the shape following property which is a characteristic different from that of the copper plate or copper foil may not be practical if the object surface or the like to be followed is not flat, and when it exceeds 20%, there is a possibility that the morphological stability of the copper fiber nonwoven fabric may be reduced.

The method of measuring the elongation percentage of copper fiber nonwoven fabric is in accordance with JIS P8113 standard and ISO 1924-2: 1994 standard.

The tensile strength of the copper fiber nonwoven fabric used for the copper fiber nonwoven fabric for wiring of the present invention is preferably 2 N/10 mm or more, and more preferably 5 N/10 mm or more. If it is less than 2 N/10 mm, the pressure of the flowing gas may cause the copper fibers in the copper fiber nonwoven fabric to fall off or the copper fiber nonwoven fabric to break depending on the use mode.

The method of measuring the tensile strength of the copper fiber nonwoven fabric is in accordance with JIS P8113 standard and ISO 1924-2: 1994 standard.

Subsequently, other metal components and other components other than the metal components used in the copper fiber nonwoven fabric for wiring of the present invention will be described in detail below.

### (Other Metal Components)

Specific examples of the other metal components used for the copper fiber nonwoven fabric for wiring according to the present invention are not particularly limited, although stainless steel, iron, aluminum, bronze, brass, nickel, chromium and the like can be exemplified, and it may be a noble metal such as gold, platinum, silver, palladium, rhodium, iridium, ruthenium and osmium.

(Other Components Other than Metal Components)

As specific examples of other components other than the metal component used for the copper fiber nonwoven fabric for wiring according to the present invention, a polyethylene terephthalate (PET) resin, a polyvinyl alcohol (PVA), a polyolefin such as polyethylene and polypropylene, a polyvinyl chloride resin, an aramid resin, nylon, an acrylic resin, an organic substance of these fibrous materials provided with a binding property and a supporting property, or the like can be used in a place including the binding portion.

Subsequently, the coating layer and the resin layer used for the copper fiber nonwoven fabric for wiring of the present invention will be described in detail below.

### (Coating Layer and Resin Layer)

In the copper fiber nonwoven fabric for wiring of the present invention, for preventing the oxidation, rust, discoloration or corrosion and reducing the contact resistance or the like of the copper fiber nonwoven fabric for wiring, if required, a coating layer may be formed by plating with a conductive metal, immersion in an aqueous solution of a discoloration inhibitor or the like with respect to a specific region or the entire region of the surface of the copper fiber nonwoven fabric for wiring. Subsequently, a resin layer may be formed, as needed, in order to facilitate processing for bending the copper fiber nonwoven fabric for wiring, and in order to sufficiently maintain the shape of the copper fiber nonwoven fabric for wiring and to ensure insulation with the peripheral parts, with respect to at least one of the surface of the coating layer and the surface other than that of the coating layer of the copper fiber nonwoven fabric for wiring further having a coating layer.

The above-described conductive metal is a metal other than copper, and is preferably a metal having high electrical conductivity and an effect of preventing oxidation of copper. The conductive metal is preferably at least one metal selected from gold, palladium, platinum, silver, nickel and tin. More specifically, Ni plating having favorable physical properties such as corrosion resistance, hardness and flexibility, and also a color tone that is not easily discolored is more preferable, and it is still more preferable to further apply Sn plating or Au plating on top of the Ni plating from the viewpoint of reducing the contact resistance.

The above-mentioned discoloration inhibitor is a kind of rust inhibitor, and for example, a known inhibitor such as an aqueous solution of benzotriazole can be used.

As a resin component that constitutes the above resin layer, those having sufficient strength as a coating film after curing, such as a thermosetting resin, a thermoplastic resin and an ionizing radiation curable resin can be used without particular limitations. Among these, it is preferable to use a thermoplastic resin or an ionizing radiation curable resin which can be efficiently cured by a simple processing operation, and it is more preferable to use any of an ultraviolet curable resin and a visible light curable resin among the ionizing radiation curable resins.

The ultraviolet curable resin used for the resin component that constitutes the resin layer of the present invention contains at least a photopolymerizable oligomer or photopolymerizable monomer, and a photopolymerization initiator.

As the photopolymerizable oligomer, an oligomer having two or more functional groups with an unsaturated double bond can be used, and as the functional group having an unsaturated double bond, for example, at least one selected from the group consisting of an acryloyl group, a methacryloyl group, an allyl group, and a vinyl group can be used.

As such an oligomer, for example, at least one selected from the group consisting of an epoxy acrylate-based oligomer, an epoxidized oil acrylate-based oligomer, a urethane acrylate-based oligomer, a polyester urethane acrylate-based oligomer, a polyether urethane acrylate-based oligomer, a polyester acrylate-based oligomer, a polyether acrylate-based oligomer, a vinyl acrylate-based oligomer, a silicone acrylate-based oligomer, a polybutadiene acrylate-based oligomer, a polystyrene ethyl methacrylate-based oligomer, a polycarbonate dicarbonate-based oligomer, an unsaturated polyester-based oligomer, and a polyethylene/thiol-based oligomer can be used.

As the photopolymerizable monomer, a known compound having at least one functional group selected from the group consisting of an acryloyl group, a methacryloyl group, an allyl group and a vinyl group in the molecule can be used.

The photopolymerization initiator is a compound having a function of initiating a polymerization reaction of a photopolymerizable oligomer or a photopolymerizable monomer, and has a role of generating free radicals by ultraviolet irradiation. These free radicals are necessary for the ultraviolet curing. The photopolymerization initiator is a substance that absorbs light of a specific wavelength from ultraviolet rays to enter an excited state and generates radicals. As such a photopolymerization initiator, for example, at least one selected from the group consisting of a benzoin ether-based initiator, a ketal-based initiator, an acetophenone-based initiator, a benzophenone-based initiator and a thioxanthone-based initiator can be used. As the photopolymerization initiator, various compounds can be used depending on the purpose.

Furthermore, the ultraviolet curable resin according to the present embodiment can contain at least one of the following additives. As the additive, photopolymerization initiation aids, adhesion inhibitors, fillers, plasticizers, non-reactive polymers, colorants, flame retardants, flame retardant aids, softening inhibitors, mold release agents, desiccants, dispersing agents, wetting agents, suspending agents, thickening agents, antistatic agents, antielectrostatic agents, matting agents, antiblocking agents, antiskinning agents, surfactants, or the like can be used.

Further, the visible light curable resin used for the resin component constituting the resin layer of the present invention is a resin which is cured by irradiation with light of about 400 nm or more. When such a visible light curable resin is used, since curing with a simple irradiation system such as a halogen lamp is possible, the cost of an irradiation apparatus can be reduced. As the visible light curable resin, for example, VL series manufactured by ThreeBond Co., Ltd. can be used. Further, the visible light curable resin can also contain at least one of the above-described additives, if necessary.

### (Characteristics of Coating Layer and Resin Layer)

The thickness of the coating layer of the fiber nonwoven fabric used for the copper fiber nonwoven fabric for wiring of the present invention can be adjusted to any thickness, but is preferably, for example, from 0.1 μm to 10 μm. If it exceeds 10 μm, when a force such as bending is applied to a portion of the coating layer, cracks may occur, which may cause detachment of the coating layer. If it is less than 0.1 μm, for example, when it reaches a high temperature of 100° C. or higher, a problem of coating strength may arise. The thickness of the coating layer of the copper fiber nonwoven fabric can be measured by observing the cross section of the copper fiber nonwoven fabric using an optical microscope.

The thickness of the resin layer of the copper fiber nonwoven fabric used for the copper fiber nonwoven fabric for wiring of the present invention can be adjusted to any thickness and can be appropriately determined depending on the material, but it is preferably, for example, from 1 μm to 1 mm. In particular, when the resin layer is formed by a polymer of epoxy acrylate, urethane acrylate or acrylate monomers, the film thickness thereof is preferably set to about 100 μm to 800 μm. The thickness of the resin layer of the copper fiber nonwoven fabric can also be measured in the same manner as for the thickness of the coating layer of the copper fiber nonwoven fabric by observing the cross section of the copper fiber nonwoven fabric using an optical microscope.

Subsequently, the production of the copper fiber nonwoven fabric for wiring of the present invention and the production of the coating layer and the resin layer on the copper fiber nonwoven fabric for wiring will be described in detail below, although the production of the copper fiber nonwoven fabric for wiring of the present invention, the coating layer and the resin layer is not limited thereto.

### (Production of Copper Fiber Nonwoven Fabric)

As a method of obtaining the copper fiber nonwoven fabric for wiring of the present invention, a dry method in which a copper fiber or a web mainly composed of copper fibers is subjected to compression molding, a wet paper making method in which paper is made by using a copper fiber or a raw material mainly composed of copper fibers, or the like can be employed.

When a copper fiber nonwoven fabric is obtained by a dry method, it can be produced by subjecting a copper fiber or a web mainly composed of copper fibers obtained by a card method, an air laid method or the like to compression molding. At this time, a binder may be impregnated between the fibers in order to provide bonding between the fibers. Although the binder is not particularly limited, for example, in addition to organic binders such as acrylic adhesives, epoxy adhesives and urethane adhesives, inorganic adhesives such as colloidal silica, water glass and sodium silicate can be used. Instead of impregnating the binder, the surface of the fiber may be coated with a heat-adhesive resin in advance, and a copper fiber or an aggregate mainly composed of copper fibers may be laminated, followed by pressurization and thermal compression.

In the case of obtaining a copper fiber nonwoven fabric by a wet paper making method, it can be produced by dispersing a copper fiber or the like in water and forming the resultant into a sheet. More specifically, for example, a copper fiber or a slurry mainly composed of copper fibers is prepared using a stirring mixer, and a filler, a dispersing agent, a thickening agent, a defoaming agent, a paper strengthening agent, a sizing agent, a flocculant, a colorant, a fixing agent or the like is appropriately added thereto.

In addition, as fibrous materials other than the copper fiber, an organic fiber or the like that exhibits a binding property by heating and melting, such as a polyethylene terephthalate (PET) resin, a polyvinyl alcohol (PVA), a polyolefin such as polyethylene and polypropylene, a polyvinyl chloride resin, an aramid resin, nylon and an acrylic resin, can also be added into the slurry. For example, when providing a binding portion between the copper fibers by sintering, it is preferable that there is no organic fiber or the like present between the copper fibers because the binding portion can be easily provided in a reliable manner.

When forming a copper fiber without the presence of an organic fiber or the like as described above, the difference in the true density between water and the copper fiber and the excessive entanglement of the copper fibers tend to form aggregates such as the so-called lumps. For this reason, it is preferable to appropriately use a thickening agent. Further, in the slurry in the stirring mixer, metal fibers with a large true density tend to settle on the bottom of the mixer. For this reason, it is preferable to use a slurry in which the metal fiber ratio is relatively stable as a papermaking slurry, excluding a portion close to the bottom.

Next, a wet paper making process is carried out in a paper machine using the above-mentioned slurry. As the paper machine, a cylinder paper machine, a Fourdrinier paper machine, a short net paper machine, an inclined paper machine, a combination paper machine obtained by combining the same or different types of paper machines from these, or the like can be used. The wet paper after paper making can be dried using an air dryer, a cylinder dryer, a suction drum dryer, an infrared dryer or the like to obtain a sheet.

At the time of dewatering, it is preferable to equalize the water flow rate of dewatering in the plane of the paper making mesh. By making the water flow rate constant, since turbulent flow and the like at the time of dewatering can be suppressed, and the rate at which the copper fibers settle to the paper making mesh can be made uniform, it becomes easy to obtain a copper fiber nonwoven fabric with high homogeneity. In order to make the water flow rate constant at the time of dewatering, it is possible to take measures such as elimination of structures that may become an obstacle for the water flow under the paper making mesh.

Furthermore, it may be produced through a fiber entanglement treatment step of intertwining with each other copper fibers or components mainly composed of copper fibers forming a wet sheet containing the moisture on the mesh. Here, as the fiber entanglement treatment step, for example, it is preferable to adopt a fiber entanglement treatment step in which a high pressure water jet stream is jetted to the wet sheet surface. More specifically, by arranging a plurality of nozzles in a direction orthogonal to the sheet flow direction and jetting high pressure water jet streams simultaneously from the plurality of nozzles, it is possible to intertwine the copper fibers or fibers mainly composed of copper fibers with each other throughout the entire sheet. After undergoing the above steps, the wet sheet is taken up after a dryer step.

The copper fiber nonwoven fabric produced by the above-mentioned steps may be subjected to a pressing (pressurizing) step, for example, before binding the copper fibers with each other. It is preferable because by carrying out the pressing step before binding, the binding portion can be easily provided in a reliable manner between the copper fibers in the subsequent binding step, and the homogeneity of the copper fiber nonwoven fabric can be easily improved.

Further, the pressing may be carried out under heating or without heating, but when the copper fiber nonwoven fabric contains an organic fiber or the like which exhibits a binding property by heating and melting, heating at a temperature equal to or higher than the melting start temperature thereof is effective, and in the case of being composed of copper fibers alone, the pressurization process alone may be sufficient. Furthermore, the pressure at the time of pressurization process may be appropriately set in consideration of the thickness of the copper fiber nonwoven fabric, but, for example, in the case where the copper fiber nonwoven fabric has a thickness of about 170 μm, because the copper fiber nonwoven fabric can be easily provided with homogeneity, the above process is preferably carried out with a linear pressure of less than 300 kg/cm, and more preferably less than 250 kg/cm. Moreover, the space factor of the copper fiber nonwoven fabric can also be adjusted by this pressing step.

As the method of binding the copper fibers of the copper fiber nonwoven fabric adjusted in this manner with each other, a method of sintering the copper fiber nonwoven fabric, a method of binding by chemical etching, a method of laser welding, a method of binding using induction heating (IH), a chemical bonding method, a thermal bonding method and the like can be used. Among them, the method of sintering the copper fiber nonwoven fabric can be suitably used from the viewpoint that the metal fibers are fixed and easily stabilized by carrying out the binding process in a reliable manner. FIG. 2 is a SEM cross-sectional photograph showing an example of a state where copper fibers are bound to each other in the copper fiber nonwoven fabric for wiring of the embodiment (Example 1) of the present invention, which is obtained by SEM observation of a cross section of the copper fiber nonwoven fabric where the copper fibers are bound by sintering.

In order to sinter a metal fiber nonwoven fabric, it is preferable to include a sintering step of sintering at a temperature equal to below the melting point of the metal fiber in a vacuum or in a non-oxidizing atmosphere. In the copper fiber nonwoven fabric that has undergone the sintering step, organic matter is burnt, and the contact points of the sheet-like metal fibers composed only of metal fibers are bound to each other in this manner, so that a copper fiber nonwoven fabric with stable homogeneity is easily obtained.

Furthermore, the homogeneity of the sintered copper fiber nonwoven fabric can be enhanced more easily by being pressed (pressurized). In the copper fiber nonwoven fabric in which the fibers are randomly entangled, the fibers are shifted not only in the thickness direction but also in the surface direction by being compressed in the thickness direction. As a result, the effect of facilitating the placement of copper fibers even in the places where voids were present at the time of sintering can be expected, and the state is maintained by the plastic deformation characteristics of the copper fibers. The pressure at the time of pressing (pressurization) may be appropriately set in consideration of the thickness of the copper fiber nonwoven fabric.

### (Production of Coating Layer and Resin Layer on Copper Fiber Nonwoven Fabric for Wiring)

In the copper fiber nonwoven fabric for wiring of the present invention obtained by the above-mentioned production method, if necessary, for the purpose of preventing the oxidation, rust, discoloration or corrosion and reducing the contact resistance or the like of the copper fiber nonwoven fabric for wiring, a coating layer is formed on a specific region or the entire region of the surface of the copper fiber nonwoven fabric for wiring by a plating treatment with a conductive metal, immersion in an aqueous solution of a discoloration inhibitor, or the like. Subsequently, if necessary, a resin layer is further formed on at least one of the surface of the coating layer and the surface other than that of the coating layer of the copper fiber nonwoven fabric for wiring, in order to facilitate processing for bending the copper fiber nonwoven fabric for wiring, and in order to sufficiently retain the shape of the copper fiber nonwoven fabric for wiring and to ensure insulation with the peripheral parts.

Here, the plating treatment includes electrolytic plating (electroplating) utilizing electricity and electroless plating utilizing chemical change in a plating solution.

More specifically, electrolytic plating is a method of electrochemically reducing and depositing a metal on the surface of a workpiece (cathode) from an aqueous solution of a metal salt by an external current. It is a general and inexpensive processing method, and furthermore, plating of metals of a wide range from heavy metals to precious metals can be performed, and is also excellent in corrosion resistance.

Further, more specifically, electroless plating is a method of chemically reducing and depositing metal ions in a plating solution, and there are autocatalytic and non-autocatalytic processes. As an advantage, the finish is uniform with no unevenness compared to that obtained by electrolytic plating, and it is excellent in wear resistance.

The plating treatment in the present invention may be appropriately selected according to the application using these known techniques.

For example, after the surface of a copper fiber nonwoven fabric for wiring in a state in which masking with a tape or the like is performed at a location where a coating layer is not formed is subjected to Ni plating for rust prevention by electrolytic plating, Sn plating or Au plating for contact resistance reduction is further applied thereon by electrolytic plating.

Alternatively, the plating treatment may be conducted by immersing only a portion to be plated in an electrolytic solution.

A known technique such as an aqueous solution treatment with benzotriazole, for example, can be used for the immersion into an aqueous solution of the discoloration inhibitor described above.

Subsequently, regarding resin layer formation, a resin component is applied to at least one of the surface of the coating layer and the surface other than that of the coating layer of the copper fiber nonwoven fabric for wiring. Although the method of applying the resin component is not particularly limited, it can be carried out using, for example, a roll coater, a bar coater, a gravure coater, a spray coater, a dip coater or the like. At this time, the viscosity of the resin component to be applied at 25° C. is preferably from 10 Pa·s to 1,000 Pa·s, more preferably from 20 Pa·s to 200 Pa·s, and still more preferably from 30 Pa·s to 100 Pa·s. As a result, it becomes possible to suppress the liquid dripping of resin and to obtain a substantially uniform coating thickness. The method of adjusting the viscosity is not particularly limited, but in the case of an ionizing radiation curable resin, for example, it is preferable to increase the molecular weight of the photopolymerizable oligomer or the photopolymerizable monomer or to use a rheology control agent for adjustment.

Subsequently, energy, such as light and heat, is irradiated to the copper fiber nonwoven fabric for wiring to which the resin component has been applied, depending on the type of the resin component. The irradiation amount and the irradiation time of energy can be appropriately set according to the resin component to be used and the coating amount. The resin component is instantaneously cured by the irradiation of energy before the occurrence of the resin deviation, and the resin layer is formed on at least one of the surface of the copper fiber nonwoven fabric and the surface of the coating layer.

Ionizing radiation curable resins are known to cause reaction inhibition upon contact with oxygen during curing. The cause of this reaction inhibition is that since oxygen in the air reacts with radicals generated by the photopolymerization initiator to cause the radicals to disappear and the polymerization reaction of the ionizing radiation curable resin decreases, curing of the resin is not sufficiently promoted. Therefore, it is preferable to perform light energy irradiation to the ionizing radiation curable resin in a nitrogen gas atmosphere. As a result, the disappearance of radicals due to the reaction with oxygen in the air can be suppressed, and the curing reaction can be efficiently advanced.

Further, after the resin component is cured by irradiation of energy, a step of cooling the resin layer may be performed if necessary. As a method of cooling the resin layer, for example, a method of blowing air for cooling can be mentioned.

Subsequently, the homogeneity of the copper fiber nonwoven fabric for wiring of the present invention will be described in detail below.

### (Homogeneity of Copper Fiber Nonwoven Fabric for Wiring)

The copper fiber nonwoven fabric for wiring of the present invention preferably has a CV value which is a coefficient of variation of the basis weight per 1 cm² according to JIS Z 8101 standard of 10% or less. The method of determining the coefficient of variation of basis weight is, for example, according to the following method.

1. The copper fiber nonwoven fabric for wiring to be measured is cut into 1 cm² square to obtain individual pieces of copper fiber nonwoven fabric for wiring.

2. Each of the individual pieces is weighed with a high precision analytical balance (for example, BM-252 (product name) manufactured by A & I Co., Ltd.).

3. In consideration of the possibility that the individual pieces are not strictly squares, the distances near the centers of the two parallel sides are measured, and the measured values are used as a vertical length and a horizontal length, respectively.

4. The area of each individual piece is calculated from the vertical and horizontal lengths.

5. The basis weight of each individual piece is calculated by dividing the mass by the area.

6. The standard deviation of the basis weight of all individual pieces is divided by the average value to calculate a CV value which is a coefficient of variation of the basis weight of individual pieces of the copper fiber nonwoven fabric for wiring.

The coefficient of variation can be stabilized by measuring, for example, 100 or more individual pieces. Further, when the copper fiber nonwoven fabric for wiring to be measured does not reach 1 cm², a value converted to 1 cm² is taken as a CV value which is a coefficient of variation.

Since the basis weight is an index representing the weight per unit area, the space factor of each individual piece can also be said to be a stable value when the coefficient of variation of the basis weight is equal to or less than a certain value. That is, when the coefficient of variation of basis weight is 10% or less, it can be said that there are no extreme lumps or voids present in the copper fiber nonwoven fabric for wiring, and, also as to the space factor value, that the copper fiber nonwoven fabric for wiring with sufficient homogeneity is obtained.

### EXAMPLES

Next, the present invention will be described more specifically with reference to Examples and Comparative Examples, but the present invention is in no way limited by these examples.

### (Thickness Measurement)

The thicknesses of the copper fiber nonwoven fabric for wiring obtained in the example and the copper foil of the comparative example were measured with a measuring terminal having a diameter of 15 mm using a Digimatic indicator ID-C112X manufactured by Mitutoyo Corporation. The thickness of the obtained sheet was measured at 9 points, and the average value was taken as the thickness.

### (Size Measurement)

The dimensions of the lengths of the short sides and the long sides of the copper fiber nonwoven fabric for wiring obtained in the example and the copper foil of the comparative example were measured using a carpenter's square (JIS Grade 1).

### (Space Factor)

The space factors of the copper fiber nonwoven fabric for wiring obtained in the example and the copper foil of the comparative example were calculated as follows.

Space factor of copper fiber nonwoven fabric for wiring (%)=(basis weight of copper fiber nonwoven fabric for wiring)/((thickness of copper fiber nonwoven fabric for wiring)×(true density of copper fiber))×100

Space factor of copper foil (%)=(bulk density of copper foil)/(true specific gravity of material)×100

### (Measurement of Elongation Percentage and Tensile Strength)

According to JIS P8113 standard and ISO 1924-2: 1994 standard, the area of the test piece was adjusted so as to be 15 mm×180 mm, and the elongation percentage and tensile strength of the copper fiber nonwoven fabric for wiring of the example and the copper foil of the comparative example were measured at a tensile speed of 30 mm/min.

### (Measurement of Size of Individual Pieces)

The copper fiber nonwoven fabric for wiring of the example was cut into 24 cm×18 cm and cut into 1 cm² pieces indicated by dotted line portions in the mapping diagram shown in FIG. 7 to obtain a total of 432 individual pieces partitioned by numbers 1 to 24 and alphabets A to S (excluding the alphabet I). For the dimensions of individual pieces of the copper fiber nonwoven fabric for wiring, although a caliper with a minimum reading of 0.05 mm was used, in consideration of the possibility that the individual pieces were not strictly squares, the distance near the centers of the two parallel sides was measured with the caliper, and the measured values were taken as vertical and horizontal lengths, and the area of each individual piece was calculated from the vertical and horizontal lengths.

### (Measurement of Mass of Individual Pieces)

The masses of the total of 432 individual pieces of the copper fiber nonwoven fabric for wiring obtained in the example were weighed using a high precision analytical balance (BM-252 (product name) manufactured by A & I Co., Ltd.).

### (Coefficient of Variation of Basis Weight of Individual Pieces)

The coefficient of variation (CV value) of the basis weight of the total of 432 individual pieces of copper fiber nonwoven fabric for wiring obtained in the example was calculated by calculating the basis weight of each individual piece from the area and the mass, and dividing the standard deviation of a total of 432 points by the average value.

### (Average Space Factor)

For the average space factor of a total of 432 individual pieces of the copper fiber nonwoven fabric for wiring obtained in the example, the arithmetic mean of the space factors of the copper fiber nonwoven fabric for wiring at a total of 432 points, which was calculated according to the formula of the space factor of the copper fiber nonwoven fabric for wiring in the example, was taken as an average space factor value.

### Example 1

### (Production of Copper Fiber Nonwoven Fabric for Wiring)

Copper fibers having an average fiber diameter of 18.5 μm, an average fiber length of 3 mm and a substantially annular cross-sectional shape, which were obtained by sufficiently loosening, and then cutting, each fiber before cutting a bundle of long fibers of copper, were dispersed in water, and a thickening agent was added as appropriate to form a papermaking slurry.

Using a papermaking slurry obtained by removing a portion with a high copper fiber concentration at the bottom of the mixer from the papermaking slurry obtained above, a basis weight of 300 g/m² as a measure was charged on a paper making mesh, and after dewatering and drying, a copper fiber nonwoven fabric before sintering was obtained.

Thereafter, the copper fiber nonwoven fabric was pressed at a linear pressure of 80 kg/cm at normal temperature and then heated at 1,020° C. for 40 minutes in an atmosphere of 75% hydrogen gas and 25% nitrogen gas to sinter the copper fibers, and pressed by a load of 240 kg/cm in a thickness direction after sintering, to obtain the copper fiber nonwoven fabric for wiring of Example 1.

The thickness, the space factor and the tensile strength of the obtained copper fiber nonwoven fabric for wiring were 101 μm, 33.5%, and 7 N/10 mm, respectively.

Next, the obtained copper fiber nonwoven fabric was cut into 24 cm×18 cm and cut into 1 cm² pieces indicated by dotted line portions in the mapping diagram shown in FIG. 7 to obtain a total of 432 individual pieces partitioned by numbers 1 to 24 and alphabets A to S (excluding the alphabet I). The basis weight and the like of each individual piece were calculated from the measured values of the mass and the area of the individual piece. The coefficient of variation (CV value) of the basis weight calculated from the standard deviation and the average value of all the individual pieces was 3.1, and the average space factor was 32.3%.

FIG. 1 shows a SEM cross-sectional photograph of the obtained copper fiber nonwoven fabric for wiring of Example 1, and FIG. 2 shows a SEM cross-sectional photograph showing a state where copper fibers of the copper fiber nonwoven fabric for wiring are bound to each other.

Next, the copper fiber nonwoven fabric of Example 1 produced above was cut into a rectangular shape having a width of 20 mm and a length of 110 mm, and a silver paste was applied to 10 mm of both end portions in the long side direction. After forming an end portion by heating at 250° C. for 30 minutes under a non-oxidizing atmosphere to cure the paste, an electric drill was used to form a terminal hole serving as a place for applying an electric current to each terminal portion, thereby obtaining a copper fiber nonwoven fabric for evaluation.

### (Production of Copper Fiber Nonwoven Fabric for Wiring Having Gas Transfer Means)

A silicone gel sheet with a thickness of 500 μm punched to an inner diameter of 5 mm and an outer diameter of 20 mm was adhered to one end portion of a suction steel metal nozzle with an inner diameter of 7 mm, an outer diameter of 10 mm, and a total length of 40 mm at both end portions. The nozzle was brought into close vertical contact centering on the plane center position of the copper fiber nonwoven fabric for evaluation (location of 10 mm in width and 55 mm in length) to obtain a copper fiber nonwoven fabric having a gas transfer means.

### (Measurement of Temperature Change of Copper Fiber Nonwoven Fabric for Wiring Having Gas Transfer Means)

In an environment of a temperature of 25° C. and a humidity of 60%, a K thermocouple was installed and fixed with a polyimide tape (manufactured by Nitto Denko Corporation) having a width of 8 mm in an area on the surface of the copper fiber nonwoven fabric for wiring, where a gas in a standard state was allowed to pass through, on the side opposite to the metal nozzle of the copper fiber nonwoven fabric for wiring having a gas transfer means. At this time, a terminal which was insulation coated was used at the tip of the thermocouple. Subsequently, the thermocouple was connected to a temperature measuring device NR-1000 (manufactured by KEYENCE Corporation), and then the terminal was attached to the terminal hole of the copper fiber nonwoven fabric for wiring produced above with a gas transfer means. A current of 20 A was applied from the terminal, and the temperature of the copper fiber nonwoven fabric for wiring was maintained at 80° C.

Subsequently, an aspirator GAS-1 (manufactured by As One Corporation) and a flow meter RK 1710 (manufactured by Kofloc Corporation) equipped with a flow rate control mechanism were connected using a vacuum hose. Subsequently, the flow meter and the metal nozzle of the copper fiber nonwoven fabric for wiring having the gas transfer means were connected using the vacuum hose.

The flow rate was measured by the height of the float of the flow meter. The flow rate of gas (air) when not connected to the metal nozzle of the copper fiber nonwoven fabric for wiring having the gas transfer means was 6 L/min, the flow rate of gas when connected to the metal nozzle was 4 L/min, and the flow rate per 1 cm² of cross-sectional area was 20 L/min.

Thereafter, the temperature change of the copper fiber nonwoven fabric for wiring having a gas transfer means and maintained at 80° C. was measured in minutes for 5 minutes by the above-mentioned temperature measuring device.

As a result, the temperature change (drop) of the copper fiber nonwoven fabric for wiring when the gas was allowed to flow for 1 minute, with respect to the copper fiber nonwoven fabric for wiring maintained at 80° C., was 40° C.

The evaluation results of the temperature change with time of the obtained copper fiber nonwoven fabric for wiring were summarized in the graph of FIG. 4.

FIG. 4 is a graph showing the measurement results of the copper fiber nonwoven fabric for wiring of Example 1 and the copper foil of Comparative Example 1, and the vertical axis represents the surface temperature (° C.) of the evaluation sample (the copper fiber nonwoven fabric for wiring of Example 1 and the copper foil of Comparative Example 1), and the horizontal axis represents the elapsed time (minutes) from the start of air flow.

### Comparative Example 1

A copper foil having a gas transfer means was obtained in the same manner as in Example 1 except that an electrolytic copper foil having a thickness of 35 μm was used instead of the copper fiber nonwoven fabric for wiring and that the silver paste was not applied, and the temperature change thereof was measured (in an environment of a temperature of 25° C. and a humidity of 60%).

At this time, the flow rate of gas (air) was 6 L/min when the metal nozzle was not connected to the metal nozzle of the copper foil having the gas transfer means, and the flow rate of gas when connected to the metal nozzle was 0 L/min. Since this is a copper foil, unlike the copper fiber nonwoven fabric for wiring, no void is formed inside.

As a result, the temperature change (drop) of the copper fiber nonwoven fabric when the gas was allowed to flow for 1 minute with respect to the copper foil maintained at 80° C. did not occur, and the temperature remained at 80° C. and remained at 80° C. during the measurement for 5 minutes.

The evaluation results of the temperature change with time of the obtained copper fiber nonwoven fabric were summarized in the graph of FIG. 4.

Since the copper fiber nonwoven fabric for wiring of the present example is a copper fiber nonwoven fabric for wiring in which the copper fibers are partially bound to each other, many voids are formed inside the copper fiber nonwoven fabric for wiring. Therefore, it is considered that by allowing the gas in the standard state to pass through inside the copper fiber nonwoven fabric for wiring perpendicularly with respect to the plane of the copper fiber nonwoven fabric for a certain period of time at a constant flow rate, the temperature of the copper fiber nonwoven fabric for wiring could be made lower than that of the copper foil or copper plate, and the heat dissipation properties could be enhanced.

Furthermore, it is thought that since the copper fiber nonwoven fabric for wiring of the present example had a CV value serving as a coefficient of variation of basis weight of 10% or less, there were no extreme lumps or voids present in the copper fiber nonwoven fabric for wiring, the gas in the standard state was allowed to pass uniformly, and the heat dissipation effect could be further enhanced.

In addition, it is thought that since the flow rate of the gas passing through the copper fiber nonwoven fabric for wiring of the present example was 20 L/min per 1 cm² of cross sectional area, it was possible to keep the copper fiber nonwoven fabric for wiring at a constant temperature (40° C. in the case of the present example).

As described above, the copper fiber nonwoven fabric for wiring of the present invention is a copper fiber nonwoven fabric for wiring in which the copper fibers are partially bound to each other, wherein when a gas in a standard state is allowed to pass through the aforementioned copper fiber nonwoven fabric for wiring, in a state where a constant current is kept flowing to maintain a temperature of 80° C., perpendicularly with respect to a plane of the aforementioned copper fiber nonwoven fabric for wiring for 1 minute at a flow rate of 20 L/min per 1 cm² of cross sectional area, a temperature of the aforementioned copper fiber nonwoven fabric for wiring decreases by at least 30° C. Since the temperature of the copper fiber nonwoven fabric for wiring is lowered than that of a copper foil or copper plate, the heat dissipation properties higher than those of the copper foil or copper plate can be provided.

### INDUSTRIAL APPLICABILITY

It is possible to provide a wiring material having a high heat dissipation effect.

### REFERENCE SIGNS LIST

1: Copper fiber nonwoven fabric for wiring;
2, 20: End portion;
3, 30: Terminal hole;
4, 40: Nozzle;
5, 50: Nozzle inlet end face;
6, 60: Nozzle outlet end face;
7, 70: Thermocouple;
8: Gas channel;
9: Gas channel inlet end face;
10: Gas channel outlet end face;
100, 200: Copper fiber nonwoven fabric for wiring;
201: Wiring unit 1;

1. A copper fiber nonwoven fabric for wiring in which copper fibers are partially bound to each other,
wherein when a gas in a standard state is made to pass through said copper fiber nonwoven fabric for wiring, in a state where a constant current is kept flowing to maintain a temperature of 80° C., perpendicularly with respect to a plane of said copper fiber nonwoven fabric for wiring for 1 minute at a flow rate of 20 L/min per 1 cm² of cross sectional area, a temperature of said copper fiber nonwoven fabric for wiring decreases by at least 30° C.

2. The copper fiber nonwoven fabric for wiring according to claim 1, wherein an average fiber diameter of said copper fibers is from 1 μm to 30 μm,
a thickness of said copper fiber nonwoven fabric is from 20 μm to 5 mm,
a space factor of said copper fiber nonwoven fabric is 50% or less, and
a coefficient of variation of basis weight of said copper fiber nonwoven fabric is 10% or less.

3. A wiring unit comprising: the copper fiber nonwoven fabric for wiring according to claim 1; and a gas passage means for allowing a gas to pass through said copper fiber nonwoven fabric for wiring.

4. The wiring unit according to claim 3, wherein the said gas passage means comprises a depressurization mechanism for depressurizing the inside thereof.

5. A wiring unit in which the copper fiber nonwoven fabric for wiring according to claim 1 is accommodated in a gas channel through which a gas flows.

6. A method for cooling a copper fiber nonwoven fabric for wiring, the method comprising
allowing a gas to pass through a copper fiber nonwoven fabric for wiring in which copper fibers are partially bound to each other, thereby lowering a temperature of said copper fiber nonwoven fabric for wiring.

7. A method for controlling a temperature of a copper fiber nonwoven fabric for wiring, the method comprising:
a step of energizing a copper fiber nonwoven fabric for wiring in which copper fibers are partially bound to each other; and
a step of allowing a gas to pass through said copper fiber nonwoven fabric for wiring, thereby controlling the temperature thereof.

8. A method for controlling a temperature of a copper fiber nonwoven fabric for wiring, the method comprising:
a step of allowing a gas to pass through a copper fiber nonwoven fabric for wiring in which copper fibers are partially bound to each other; and
a step of energizing said copper fiber nonwoven fabric for wiring.
